(19) United States
(12) Patent Application Publication
(10) Pub. No.: US 2014/0197315 A1
(43) Pub. Date: Jul. 17, 2014

(54) SPECTRAL VARIANCE COMPRESSIVE DETECTION SYSTEM, DEVICE, AND PROCESS

(71) Applicant: CIRTEMO, LLD, Cayce, SC (US)

(72) Inventor: Ryan J. PRIORE, Wexford, PA (US)

(73) Assignee: CIRTEMO, LLD, Cayce, SC (US)

(21) Appl. No.: 14/153,462

(22) Filed: Jan. 13, 2014

Related U.S. Application Data
(60) Provisional application No. 61/752,728, filed on Jan. 15, 2013.

(51) Int. Cl. G01N 21/25

(52) U.S. Cl. CPC G01N 21/255
USPC 250/339.01

(57) ABSTRACT

An optical analysis system, optical device, and optical analysis process are disclosed. The system includes one or more optical filter mechanisms disposed to receive light from a light source and a detector mechanism in operative communication with the one or more optical filter mechanisms to measure properties of filtered light, filtered by the one or more optical filter mechanisms from the received light. The one or more optical filter mechanisms are configured so that the magnitude of the properties measured by the detector mechanism is proportional to information carried by the light filtered. The device is capable of including one of the one or more optical filter mechanisms in the system. The process is capable of relying upon the system, filtering light, and measuring properties of the filtered light.

### PRIORITY

The present application is a Non-provisional Patent Application claiming priority and benefit to U.S. Provisional Patent Application No. 61/752,728, filed Jan. 15, 2013, the entirety of which is hereby incorporated by reference.

### FIELD OF THE INVENTION

The present disclosure is in the technical field of spectroscopy. More particularly, the disclosure relates to spectral variance compressive detection systems, devices, and processes.

### BACKGROUND

Chemical analysis usually consists of two processes: calibration and prediction. Calibration is the process of defining a mathematical model to relate an instrumental response or responses to a chemical or physical property of a sample. An instrument may yield one, two or multiple responses which are termed as variables. One output variable is referred to as a univariate measurement whereas multiple output variables are referred to as a multivariate measurement. Prediction is the act of using a calibration model based on a known chemical or physical property of a sample and predicting the properties of future samples from the instrumental output response variables.

A specific example of multivariate calibration and prediction in analytical spectroscopy is employing measured optical phenomena like absorbance (UV-visible, near infrared or long wave infrared), fluorescence or Raman data at specific wavelengths to predict the concentration of a target analyte in a gas, liquid or solid. Analytical chemists strive to produce linear calibration models which possess the highest level of accuracy and precision to selectively relate an instrumental output to a property of a desired analyte species even in the presence of instrumental output interferences. These interferences may occur due to chemical or physical properties of the sample matrix or other species and ultimately affect the sensitivity of the instrumental calibration.

Calibration models capable of correlating a measured response with a chemical or physical attribute originate from the field of statistics and in chemical systems, chemometrics. Chemometrics encompasses the use of statistical information to analyze chemical data to transform measured values into information for making decisions. Hotelling published a paper in 1933 discussing the transformation of complex statistics into a set of simplified, orthogonal principal components describing the largest sources of variance in a data set. This is known today as Principal Component Analysis (PCA). PCA was further explored by Anderson in 1958, but it was not until computers were available to perform such rigorous calculations that multivariate statistics made a mainstream impact on calibrations. Prior to the 1970s, most of the chemometric implementations were done by hand which resulted in long analysis times and simplified expressions resulting in calculation variations from researcher to researcher.

Multivariate calibrations offer some distinct advantages in both analytical measurements as well as paradigm shifts in chemical analyses. Utilizing multiple variables in a calibration allows multiple components to be analyzed simultaneously. Highly correlated variables or neighboring wavelengths in spectroscopy offer increases in signal-to-noise ratios (SNR). Similar SNR enhancements may be obtained by averaging redundant measurements. Multiple calibration variables also increase the robustness of mathematical models by sampling a larger data region where interfering components may be readily observed.

In a simple system where the instrument response and analyte chemical or physical properties obey a linear relationship, Classical Least Squares (CLS) may be used to perform the univariate calibration. CLS assumes that a linear additive response exists among all of the chemical components in the sample system. Thus, for a spectrometer based instrument the response at a particular wavelength is a linear combination of the attributes of the chemical system under study. Pure spectra must also be measured to construct the calibration model in a CLS system although pure mixtures are also acceptable. Ideally all sources of measurement variance are explicitly accounted for in the model.

Using the Beer-Lambert law of absorption, an instrumental linear response of optical absorbance, A with analyte concentration, c may be expressed using the linear equation:

c 32 A(εd)⁻¹ (Equation 1)

where ε is the molar absorptivity, and d is the pathlength of the sample. The product of ε and d may be replaced with the calibration sensitivity or regression, b. The pure spectra (or pure mixture spectra) of all of the analytes are collected at unit concentrations to calculate the sensitivity values exactly in a linear regression sense.

b*=Ac⁻¹+e (Equation 2)

The b* represents the pseudo-inverse of b, and the e represents the model error according to the least squares fit. To perform a prediction of future sample component concentrations, ĉan absorbance measurement is collected and multiplied by b*.

ĉ=Ab* (Equation 3)

CLS is a well understood process with a statistically sound foundation, but it suffers most from the application in real-world systems where all sources of system variation cannot be accounted.

In a complex system where the number of analytes is unknown and thus implicitly accounting for all sources of variation, Inverse Least Squares (ILS) may be used to perform the multivariate calibration. ILS also assumes that a linear additive response exists among all of the chemical components in the sample system, but slight non-linear instrumental responses can be tolerated. Pure compound or mixture spectra are unnecessary for constructing the calibration model, and ILS offers data compression alternatives by transforming the instrumental variable space into PCs of variance. In real-world analyses, the various types of multivariate calibrations have been compared based on predictive performance, stability and the ability to deal with unmodeled interferences.

Stemming from the univariate example described above, the MLR model is constructed from two or more wavelengths that describe uncorrelated variance in the calibration set. By switching to matrix notation where matrices are boldface and the superscripts T and −1 correspond to the transpose and inverse respectively, the calculation of concentration may be expressed as:

ĉb=A

ĉbb^{T}=Ab^{T}

ĉ(bb^{T})(bb^{T})⁻¹=Ab^{T}(b

ĉ=Ab* (Equation 3)

The transpose steps are necessary because only square matrices may be inverted. When many variables or wavelengths are measured, the bb^{T} matrix cannot be inverted and is singular.

MLR attempts to calibrate a spectroscopic system by using an optimal subset of wavelengths to describe all sources of variation. There must be at least the same number of measured wavelengths in the model as there are different sources of spectral variation, and the correlation among the wavelengths must be minimized to ensure a stable inversion of the bb^{T} matrix. Various strategies have been developed in variable selection for an optimal MLR calibration. MLR can be used to design simple measurement systems based on filter photometers as opposed to expensive spectrometers, but it predominantly lacks in the multivariate advantages of signal averaging and error detection.

Linear multivariate models of complex data sets may also be developed through the transformation of the measured variables or spectral data into orthogonal basis vectors. These basis vectors, also known as principal components (PCs) model statistically significant variation in the data as well as measurement noise. Ultimately, the data dimensionality is reduced to a set of basis vectors that model only spectral and measurement variation spanning the space of the data matrix without prior knowledge of the chemical components. An example of PCA applied to NIR spectra is illustrated in FIG. 1.

A popular method of calculating the PCs of a data matrix is through the Singular Value Decomposition (SVD) algorithm. A data matrix like absorbance measurements may be decomposed into three new matrices:

X=USV^{T} (Equation 4)

where the columns of U contain the column-mode eigenvectors or PC scores of X, the diagonal of S contains the square root of the eigenvalues of X^{T}X, and the rows of V^{T} contain the row-mode eigenvectors or PC loadings of X. The first eigenvector of V^{T} corresponds to the largest source of variation in the data set, while each additional eigenvector corresponds to a smaller source of variation in the data. The scores or projections of the original absorbance vectors in the PC space are computed by multiplying the U matrix by the S matrix. FIG. 1 illustrates the data matrix relationship in SVD.

Because the PCs are orthogonal, they may be used in a straight forward mathematical procedure to decompose a light sample into the component magnitudes which accurately describe the data in the original sample. Since the original light sample may also be considered a vector in the multi-dimensional wavelength space, the dot product of the original signal vector with a PC vector is the magnitude of the original signal in the direction of the normalized component vector. More specifically, it is the magnitude of the normalized PC present in the original signal. This is analogous to breaking a vector in a three dimensional Cartesian space into its X, Y and Z components. The dot product of the three-dimensional vector with each axis vector, assuming each axis vector has a magnitude of 1, gives the magnitude of the three dimensional vector in each of the three directions. The dot product of the original signal and some other vector that is not perpendicular to the other three dimensions provides redundant data, since this magnitude is already contributed by two or more of the orthogonal axes.

Because the PCs are orthogonal, or perpendicular, to each other, the dot, or direct product of any PC with any other PC is zero. Physically, this means that the components do not interfere with each other. If data is altered to change the magnitude of one component in the original light signal, the other components remain unchanged. In the analogous Cartesian example, reduction of the X component of the three-dimensional vector does not affect the magnitudes of the Y and Z components.

PCA provides the fewest orthogonal components that can accurately describe the data carried by the light samples. Thus, in a mathematical sense, the PCs are components of the original light that do not interfere with each other and that represent the most compact description of the entire data carried by the light. Physically, each PC is a light signal that forms a part of the original light signal. Each has a shape over some wavelength range within the original wavelength range. Summing the PCs produces the original signal, provided each component has the proper magnitude. An example of reconstructing a spectrum from a reduced set of PCs is illustrated in FIG. 3.

The PCs comprise a compression of the data carried by the total light signal. In a physical sense, the shape and wavelength range of the PCs describe what data is in the total light signal while the magnitude of each component describes how much of that data is there. If several light samples contain the same types of data, but in differing amounts, then a single set of PCs may be used to exactly describe (except for noise) each light sample by applying appropriate magnitudes to the components.

Multivariate Optical Computing (MOC) combines the data collection and processing steps of a traditional multivariate chemical analysis in a single step. It offers an all-optical computing technology with little to no moving parts. MOC instrumentation is inexpensive to manufacture compared to scanning instrumentation in a compact, field-portable design. The speed benefit due to an optical regression can offer real-time measurements with relatively high SNR that realize the advantages of chemometrics in a simple instrument.

MOC may be separated into two categories defined by the method of applying a multivariate regression optically. The first focuses on the utilization of thin film interference filters called Multivariate Optical Elements (MOEs) to apply a dot product with an incident radiometric quantity yielding a single measured value related to a spectroscopically active chemical or physical property. An alternative optical regression method involves the modification of scanning or dispersive instrumentation with weighted integration intervals at each wavelength. This may be accomplished with an optical mask or by shuttering the detector or light source heterogeneously across the spectral range in intervals proportional to a calculated multivariate regression. Ultimately, an optical regression implements the complicated steps of a digital regression in a hardened apparatus where the chemometric advantages may be realized in a simple instrument that a non-expert can operate.

Interference filter pairs were introduced by Nelson et al. in 1998 as an optical regression technique. PCA was performed on Raman spectra from a polymer curing experiment to construct a multivariate regression. The positive portion of the regression vector was used as a template for designing an interference filter to express a similar dot product. The absolute value of the negative portion of the regression vector was also used as a template for an interference filter; an operation amplifier inverted the resulting signal. These filters were spatially homogeneous, and a photodiode sensed all wavelengths simultaneously. Spatial Light Modulators (SLM) and Digital Micro-mirror Devices (DMD) have also been utilized to apply spectroscopic regressions after the incident light has passed through a dispersive element. Such devices have allowed the real-time modification of the optical regression.

Compressive sensing and detection is the process in which a fully resolved waveform or image is reconstructed from a smaller set of sparse measurements. A sparse sample implies a waveform or image data set with coefficients close to or equal to zero. Compressive sensing utilizes the redundancy in information across the sampled signal similar to lossy compression algorithms utilized for digital data storage. A fully expanded data set may be created through the solution of an undetermined linear system, an equation where the compressive measurements collected are smaller than the size of the original waveform or image. To date, sensors employing MOEs have yielded a direct analytical concentration prediction or classification as opposed to reconstructing the original waveform or hyperspectral image.

A system, device, and process that show one or more improvements in comparison to the prior art would be desirable in the art.

### BRIEF DESCRIPTION OF THE INVENTION

In an embodiment, an optical analysis system includes one or more optical filter mechanisms disposed to receive light from a light source and a detector mechanism in operative communication with the one or more optical filter mechanisms to measure properties of filtered light, filtered by the one or more optical filter mechanisms from the received light. The one or more optical filter mechanisms are configured so that the magnitude of the properties measured by the detector mechanism is proportional to information carried by the light filtered.

In another embodiment, an optical device includes an optical filter mechanism capable of receiving light from a light source and capable of operation with a detector mechanism to measure properties of filtered light, filtered by the optical filter mechanism from the received light. The optical filter mechanism is configured so that the magnitude of the properties measured by the detector mechanism is proportional to information carried by the filtered light.

In another embodiment, an optical analysis process includes providing one or more optical filter mechanisms and a detector mechanism in operative communication with the one or more optical filter mechanisms, receiving light from a light source with the one or more optical filter mechanisms, filtering the received light to generate filtered light, and measuring properties of the filtered light by the optical filter mechanisms. The optical filter mechanisms are configured so that the magnitude of the properties measured by the detector mechanism is proportional to information carried by the filtered light.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is an example of near infrared (NIR) reflectance spectra reduced into independent scores in PC vector space by Principal Component Analysis (PCA); (A) Plot of NIR reflectance spectra; (B) Plot of spectroscopic variance explained (%) as a function of PC; (C) Plot of PC loading vectors 1, 2 and 3 for the NIR reflectance spectra; (D) Plot of PC scores of the NIR reflectance spectra on PC loading vectors 1, 2 and 3.

FIG. 2 is a linear algebraic diagram of Singular Value Decomposition (SVD) based on prior art where m and n correspond to rows and columns respectively, X is the spectroscopic data containing m samples measured by n wavelengths, U is the PC scores, S is the square root of the X^{T}X eigenvalues, and V^{T} is the transposed PC loading vectors.

FIG. 3 is a linear algebraic diagram of Singular Value Decomposition (SVD) based on prior art where m and n correspond to rows and columns respectively, X is the spectroscopic data containing m samples measured by n wavelengths, U is the PC scores, S is the square root of the X^{T}X eigenvalues, and V^{T} is the transposed PC loading vectors. An example decomposition of sample 3 is illustrated by the darkly shaded rows and columns.

FIG. 4 is an example reconstruction or prediction of the sample 3 reflectance spectrum from FIG. 2 by only using the first three PCs describing 97% of the spectroscopic variance. The multiplied score (U_{PC}), square root of the eigenvalue (S_{PC}) and eigenvector (V^{T}_{PC}) are summed across each retained PC. A spectroscopic residual is illustrated to demonstrate the efficiency of spectroscopic reconstruction.

FIG. 5 is a schematic of a point detection optical analysis system, according to an aspect of the disclosure for point detection.

FIG. 6 is a schematic of a point detection optical analysis system, according to an aspect of the disclosure for point detection.

FIG. 7 is a schematic of a point detection optical analysis system, according to an aspect of the disclosure for hyperspectral imaging.

FIG. 8 is a schematic of a point detection optical analysis system, according to an aspect of the disclosure for hyperspectral imaging.

FIG. 9 is a schematic of an optical filter wheel, according to an aspect of the disclosure.

FIG. 10 is a flowchart of the compressive detection and data reconstructing process.

Wherever possible, the same reference numbers will be used throughout the drawings to represent the same parts.

### DETAILED DESCRIPTION OF THE INVENTION

The present disclosure includes a system, device, and process that employ multivariate optical elements (MOEs) for use as spectral variance or PC loading vectors. These independent MOE amplitude measurements are utilized to reconstruct a fully resolved spectroscopic measurement of a sample. A fully resolved optical spectrum is calculated by linearly combining the known optical filter spectroscopic pattern vectors with the corresponding spectral variance or PC amplitude measurements.

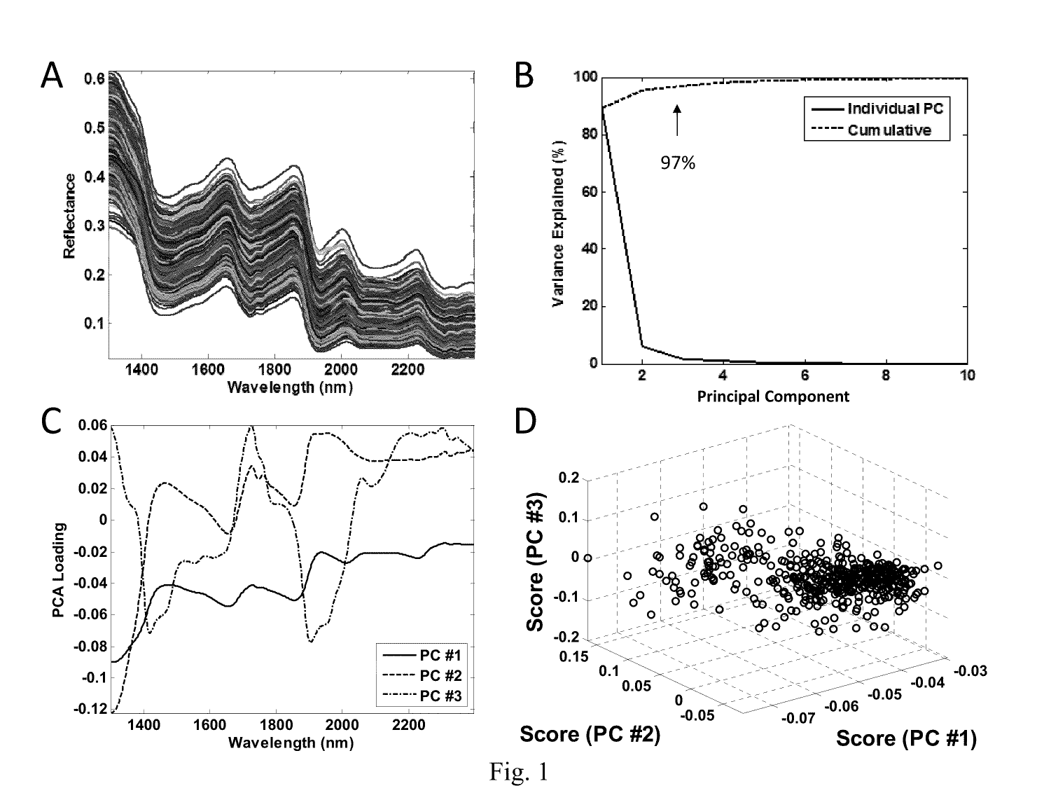

Referring now to various embodiments of the disclosure in more detail, in FIG. 1 there is shown an example of prior art of Principal Component Analysis (PCA) in which a measured optical spectral data set may be compressed into a series of loading vectors describing the various sources of spectroscopic variation within a data set and the corresponding scores of magnitudes of the various sources of variation.

In further detail, in FIG. 1A there is an example set of near infrared (NIR) reflectance spectra. In FIG. 1B an eigenvalue is calculated for each source of spectroscopic variability (or PC) calculated, and the independent and cumulative variance (%) is computed. A total of 97% of the spectroscopic variance is explained by PCs 1, 2 and 3 together. In FIG. 1C the PC loading vectors describing 97% of spectroscopic variation (and resulting rotated coordinate space) are plotted as a function of wavelength. In FIG. 1D there are score projections along PC 1 and PC 2.

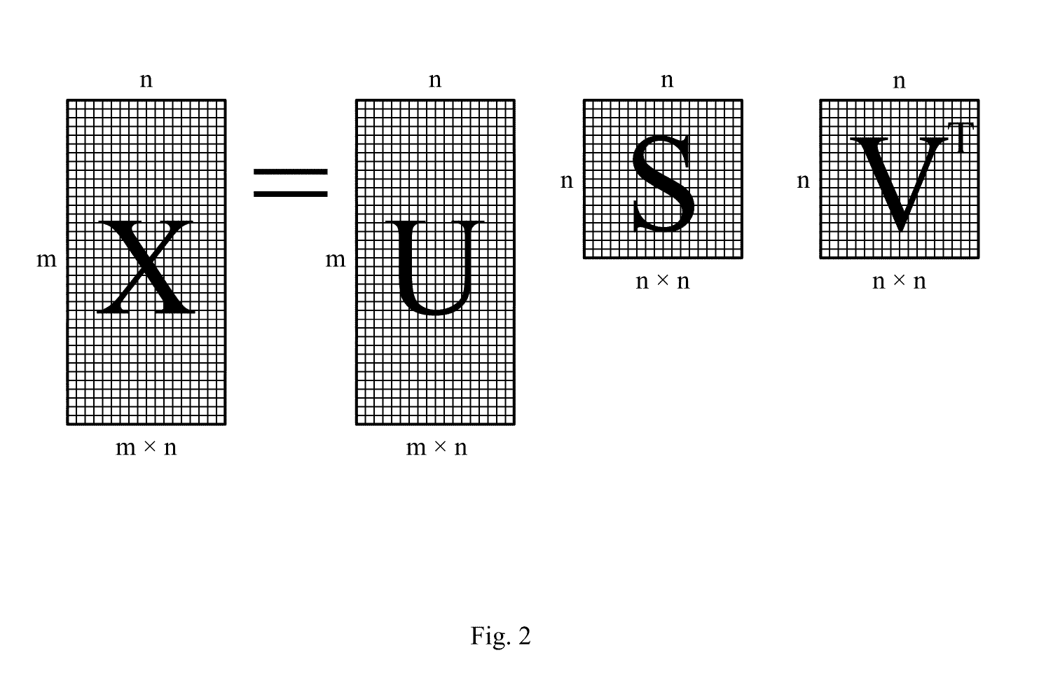

Referring now to FIG. 2, there is shown a linear algebraic example computation of PCA called Singular Value Decomposition in which the spectroscopic data (block X) can be decomposed into a series of score values (block U), residuals (block S) and loading vectors (block V^{T}).

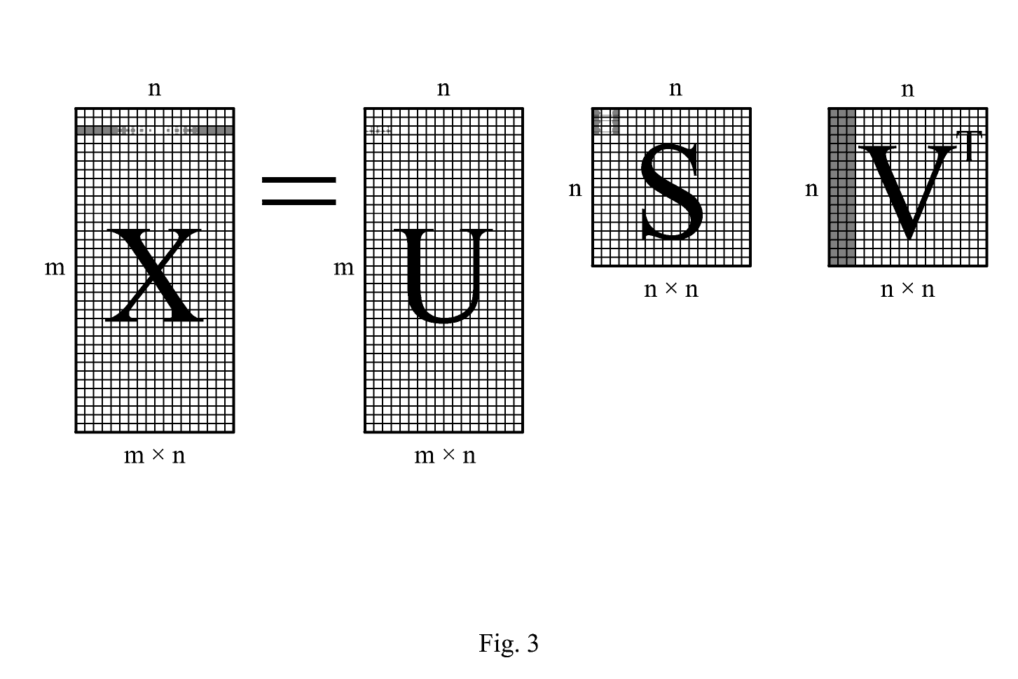

Referring now to FIG. 3, there is shown a linear algebraic example computation of PCA called Singular Value Decomposition in which the spectroscopic data (block X) can be decomposed into a series of score values (block U), residuals (block S) and loading vectors (block V^{T}). The shaded regions of each box indicate the reconstruction of the reflectance spectrum of the third sample after only retaining PCs 1, 2 and 3 which explain 97% of the spectroscopic variance.

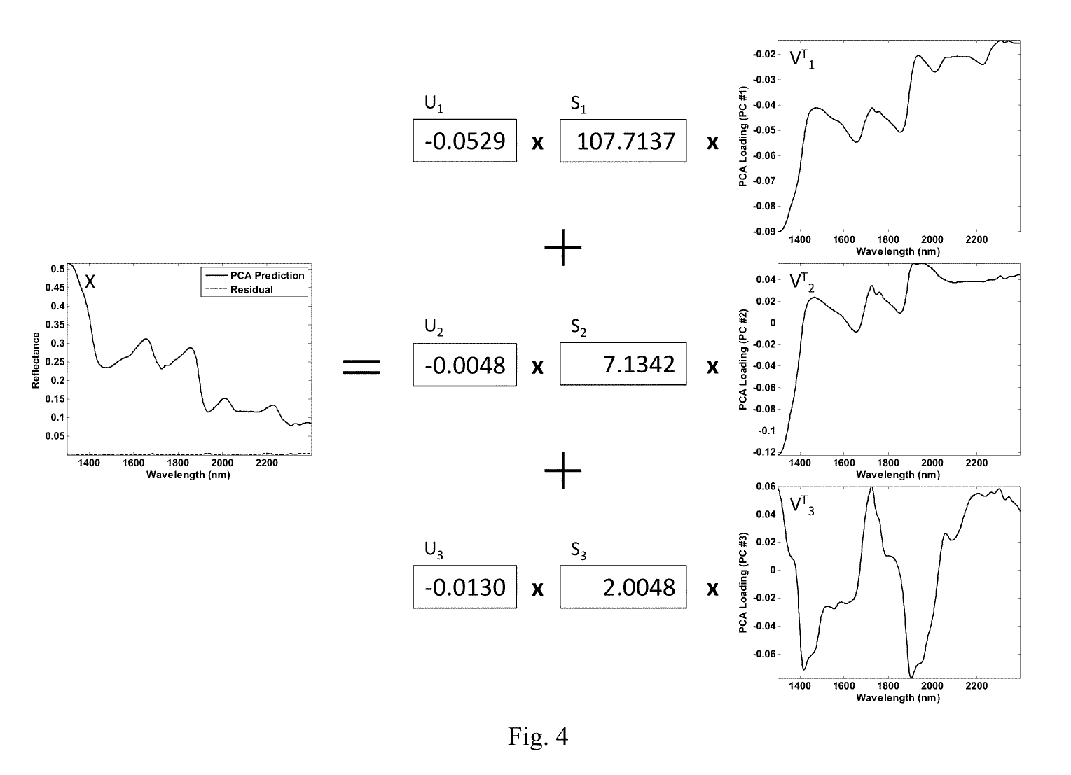

Referring now to FIG. 4, there is shown an example reconstruction or prediction of the sample 3 reflectance spectrum from FIG. 1 by only using the first three PCs describing 97% of the spectroscopic variance. The multiplied score (U_{PC}), square root of the eigenvalue (S_{PC}) and eigenvector (V^{T}_{PC}) are summed across each retained PC. A spectroscopic residual is illustrated to demonstrate the efficiency of spectroscopic reconstruction.

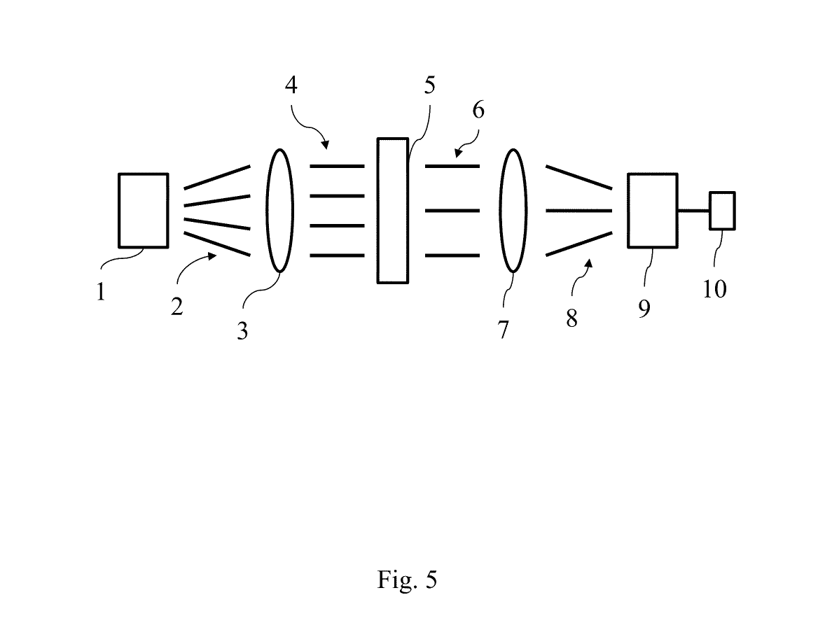

Referring now to FIG. 5, there is shown a sample (1) in which sampled light (2) is focused by a collimating lens (3) whereby the collimated light (4) is transmitted through an optical filter (5). The light (6) transmitted through the optical filter (5) is focused by a focusing lens (7), and the focused light (8) is passed to an optical detector (9) controlled by a microcontroller (10).

In further detail, in FIG. 5 the independent measurements made by the optical detector (9) are used to compute an estimate of the fully resolved wavelength spectrum of the sample.

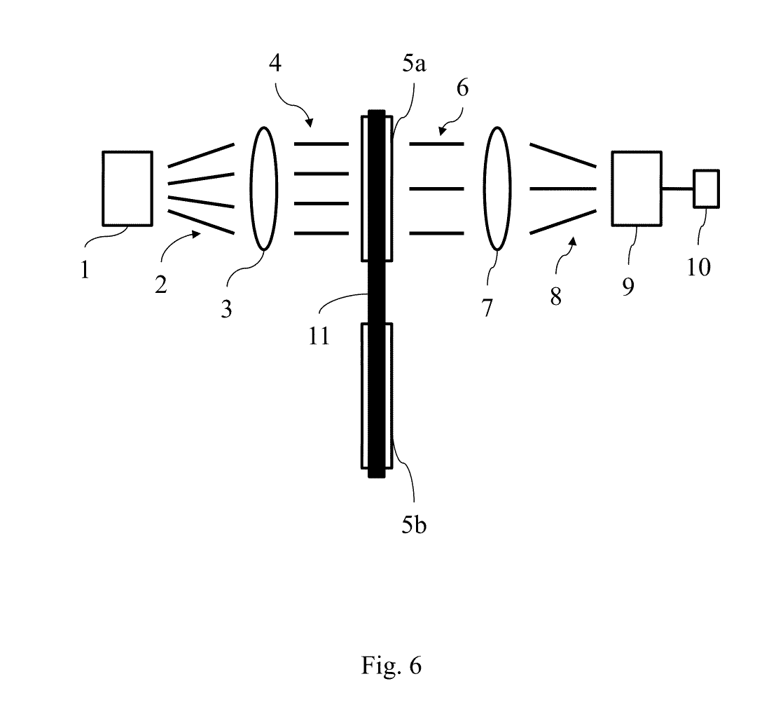

Referring now to FIG. 6, there is shown a sample (1) in which sampled light (2) is focused by a collimating lens (3) whereby the collimated light (4) is transmitted through an optical filter (5a or 5b) contained within a filter wheel (11). The light (6) transmitted through the optical filter (5a or 5b) contained within the filter wheel (11) is focused by the focusing lens (7), and the focused light (8) is passed to an optical detector (9) controlled by the microcontroller (10).

In further detail, in FIG. 6 the independent measurements made by the optical detector (9) are used to compute an estimate of the fully resolved wavelength spectrum of the sample.

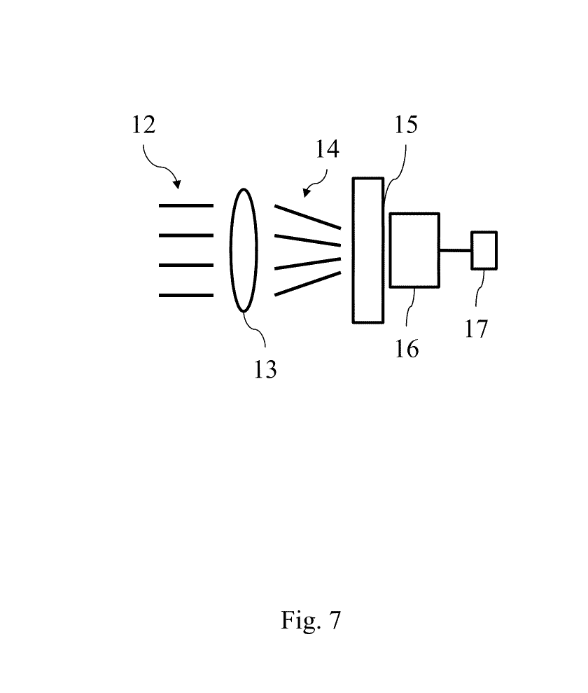

Referring now to FIG. 7, there is shown sampled light originating from a scene (12) is focused by a collection lens (13) whereby the focused light (14) is transmitted through an optical filter (15) onto an optical 2D-array detector (16) controlled by a microcontroller (17).

In further detail, in FIG. 7 the independent measurements made by the 2D-array detector (16) are used to compute an estimate of the fully resolved hyperspectral image of the sample.

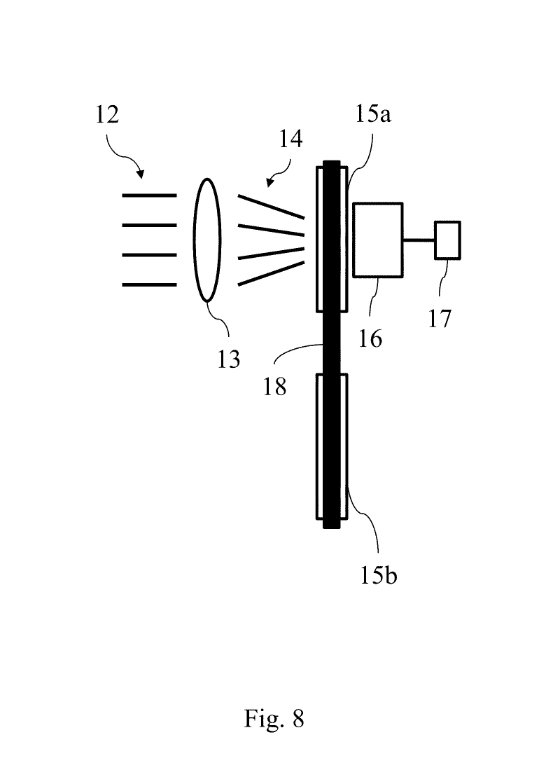

Referring now to FIG. 8, there is shown sampled light originating from a scene (12) is focused by a collection lens (13) whereby the focused light (14) is transmitted through an optical filter (15a or 15b) contained within a filter wheel (18) onto an optical 2D-array detector (16) controlled by a microcontroller (17).

In further detail, in FIG. 8 the independent measurements made by the 2D-array detector (16) are used to compute an estimate of the fully resolved hyperspectral image of the sample.

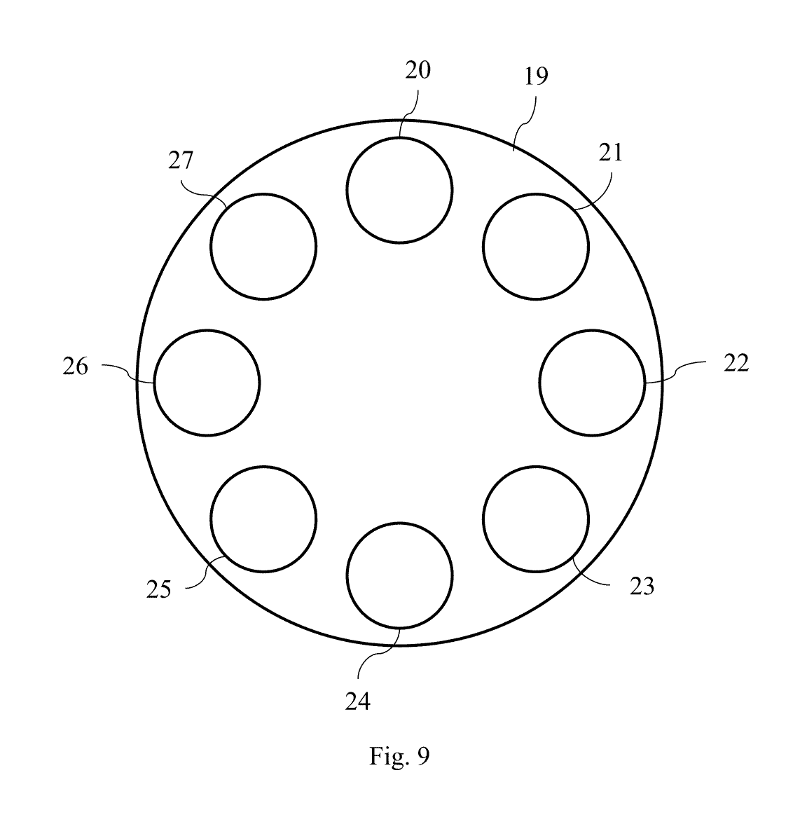

Referring now to FIG. 9, there is shown an optical filter wheel (19) which could enable multiple optical filters (20-27) to be employed by the optical analysis system.

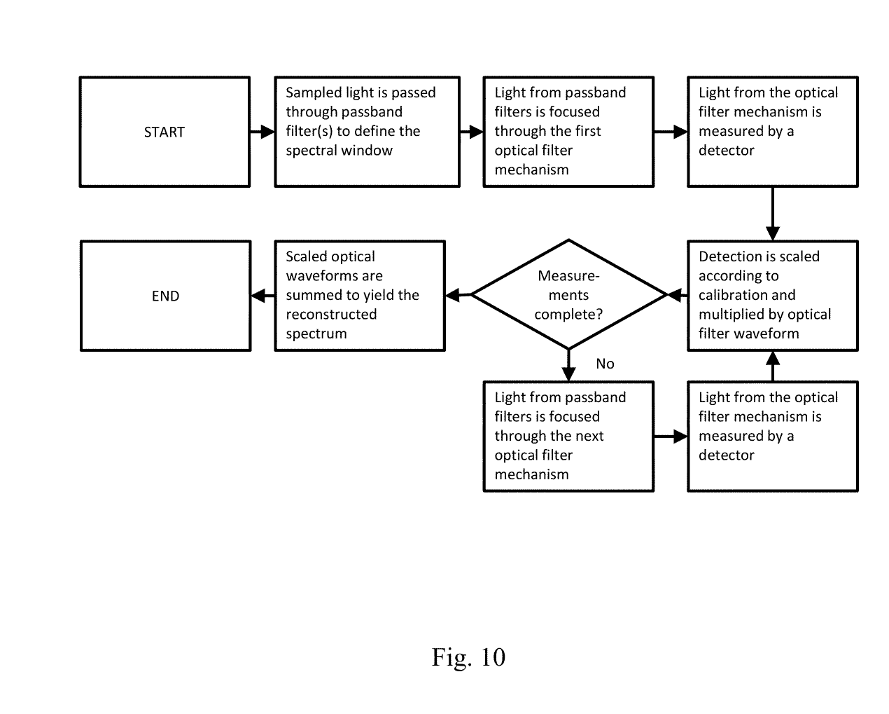

Referring now to FIG. 10, the independent detector measurements made from the unique optical filter mechanisms are utilized to reconstruct the fully resolved spectrum.

Among other things, the embodiments of the present disclosure have the ability to compute a fully resolved optical spectrum or hyperspectral image with M discrete wavelength variables from a set of N optical filter measurements where N is smaller than M.

While the invention has been described with reference to one or more embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An optical analysis system, comprising:
one or more optical filter mechanisms disposed to receive light from a light source; and
a detector mechanism in operative communication with the one or more optical filter mechanisms to measure properties of filtered light, filtered by the one or more optical filter mechanisms from the received light;
wherein the one or more optical filter mechanisms are configured so that the magnitude of the properties measured by the detector mechanism is proportional to information carried by the light filtered.

2. The system according to claim 1, wherein the one or more optical filter mechanisms contain at least one multivariate optical element.

3. The system according to claim 1, wherein the one or more optical filter mechanisms contain at least one neutral density filter.

4. The system according to claim 1, wherein the one or more optical filter mechanisms include a liquid crystal tunable filter (LCTF).

5. The system according to claim 1, wherein the one or more optical filter mechanisms include an acousto-optical tunable filter (AOTF).

6. The system according to claim 1, wherein the detector mechanism includes a point detector, wherein N unique optical filter measurements are usable to compute an estimate of the M-wavelength spectrum, wherein the number of the N unique optical filter measurements is less than M.

7. The system according to claim 1, wherein the detector mechanism includes a 2D-array detector, wherein N unique optical filter measurements are usable to compute an estimate of the M-wavelength hyperspectral image, wherein the number of the N unique optical filter measurements is less than M.

8. An optical device, comprising:
an optical filter mechanism capable of receiving light from a light source and capable of operation with a detector mechanism to measure properties of filtered light, filtered by the optical filter mechanism from the received light;
wherein the optical filter mechanism is configured so that the magnitude of the properties measured by the detector mechanism is proportional to information carried by the filtered light.

9. An optical analysis process, comprising:
providing one or more optical filter mechanisms and a detector mechanism in operative communication with the one or more optical filter mechanisms;
receiving light from a light source with the one or more optical filter mechanisms;
filtering the received light to generate filtered light; and
measuring properties of the filtered light by the optical filter mechanisms,
wherein the optical filter mechanisms are configured so that the magnitude of the properties measured by the detector mechanism is proportional to information carried by the filtered light.
